(19) United States
(12) Patent Application Publication
(10) Pub. No.: US 2010/0045835 A1
(43) Pub. Date: Feb. 25, 2010

(54) IMAGING DEVICE CHIP SET AND IMAGE PICKUP SYSTEM

(75) Inventor: Yoshiyuki Matsunaga, Kanagawa (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/376,698

(22) PCT Filed: Jul. 20, 2007
(86) PCT No.: PCT/JP2007/064330

§ 371 Date: Feb. 6, 2009

(30) Foreign Application Priority Data
Aug. 22, 2006 (JP) 2006-225398

(51) Int. Cl. H04N 5/335

(52) U.S. Cl. 348/308

(57) ABSTRACT

An imaging device chip set includes an imaging chip 11 which includes a plurality of unit pixels 21 and at least part of a peripheral circuit section 22 and a DSP chip 13 which includes a digital processing section 31 for converting and processing an image signal and remaining part of the peripheral circuit section 22. A first wiring layer is formed on a first substrate. The first wiring layer includes two or fewer layers in a photosensitive area 20 where the plurality of unit pixels are provided and three or fewer layers in the other area.

### TECHNICAL FIELD

The present invention relates to an imaging device chip set and an image pickup system and specifically relates to a chip set including a MOS type imaging chip and a digital signal processing chip used in digital cameras and the like and an image pickup system utilizing the same.

### BACKGROUND ART

In recent years, to achieve enhanced performance and downsizing of semiconductor devices, multiple functions have been integrated on one chip. In the field of solid-state imaging device, due to significant progress of technologies of digital signal processing and CMOS microfabrication, it has become possible to achieve one-chip CMOS cameras which integrally include on a single silicon substrate an image sensor for converting an optical signal received by an imaging surface to an electric signal and outputting the converted signal, and a digital signal processor (DSP) capable of high level signal processing (see Patent Document 1, for example).

Patent Document 1: Japanese Laid-Open Patent Publication No. H10-224696.

### DISCLOSURE OF INVENTION

### Problems to be Solved by the Invention

However, it has turned out that the one-chip integration contains big problems in further pursuing downsizing and enhancing performance of the solid-state imaging device.

It is necessary to downsize pixels in order that the solid-state imaging device is downsized and has more pixels. If pixels are downsized, the amount of signal input to a pixel decreases and the signal-to-noise ratio accordingly deteriorates due to optical shot noise. The optical shot noise is noise of a signal itself. If a signal has n electrons, the signal inherently has noise of √n and the S/N ratio would be n/√n=√n. Hence, if a pixel is downsized and the number of electrons (n) is reduced, the S/N ratio greatly deteriorates and it becomes impossible to reproduce a clear image.

Hence, in order to downsize the pixels, the solid-state imaging device needs to be provided with DSP having a function of suppressing the optical shot noise.

Further, the optical shot noise included in incident light is fluctuation noise of the signal itself. It is therefore difficult to reduce the absolute value of the optical shot noise, compared to the thermal noise of a transistor, which is noise of a solid-state imaging device, and a leakage current or the like of a photodiode. Hence, signal processing using DSP is necessary to make the optical shot noise less noticeable. This signal processing is complicated and the functions of the DSP become complicated. With the increase in complexity, the increased number of wirings are necessary in the DSP. As a result, it becomes necessary to increase the area for wirings and/or the number of layers included in the wiring layer in the DSP.

However, an increase in area for wirings inevitably leads to an increase in size of the solid-state imaging device. On the other hand, an increase in height of the wiring layer makes an imaging device less sensitive because light incident on the photodiode from an oblique direction is shut by the wiring layer. Larger part of light is shut by the wiring layer in particular when the cell size (pitch) of pixels is smaller, and thus, demerits of increasing the height of the wiring layer increase more.

One of solutions may be to reduce the thickness of a layer included in the wiring layer so that the height of the wiring layer is reduced. However, it is not easy to reduce the height of the wiring layer because of reliability issues and the like. Another solution may be to reduce the number of layers included in the wiring layer in the photosensitive area where pixels are formed and increase the number of layers included in the wiring layer in the area where DSP is formed. However, if parts of the wiring layer include a different number of layers and create a big step, it is difficult to form on the chip surface a microlens for collecting light on the pixels, a color filter and the like. It is therefore difficult to greatly vary the number of layers included in the wiring layer in a single chip.

Another solution may be to divide a solid-state imaging device into two chips, an imaging chip and a DSP chip, and make the imaging chip have a wiring layer which includes fewer layers than a wiring layer of the DSP chip. However, the imaging chip is not only provided with a photosensitive area where pixels are formed, but also provided with a peripheral circuit for driving the pixels. It is difficult to reduce the number of layers included in the wiring layer of the imaging chip, as well as the number of layers included in the wiring layer of the peripheral circuit. Moreover, the peripheral circuit is a digital circuit in many cases, and a digital circuit cannot be sufficiently microfabricated when provided on an imaging chip.

Another solution may be to provide the peripheral circuit for driving the pixels on the DSP chip, not on the imaging chip. In this case, however, an enormous number of wirings for connecting the imaging chip and the DSP chip are necessary.

An object of the present invention is to solve the above problems and realize an imaging chip set including an imaging chip and a DSP chip and capable of achieving an easy connection between the imaging chip and the DSP chip and small reduction in sensitivity due to microfabrication.

### Means for Solving the Problems

To achieve the above object, an imaging chip set of the present invention includes an imaging chip of which the wiring layer includes two or fewer layers in a photosensitive area and a DSP chip of which the wiring layer includes four or more layers.

Specifically, an imaging device chip set of the present invention includes: an imaging chip which is formed on a first substrate and includes a plurality of unit pixels for converting incident light to an electric signal and part of a peripheral circuit section for driving the plurality of unit pixels; and a digital signal processing chip which is formed on a second substrate and includes a digital signal processing section for converting and processing the electric signal and remaining part of the peripheral circuit section, wherein a first wiring layer is formed on the first substrate, and the first wiring layer includes two or fewer layers in a photosensitive area where the plurality of unit pixels are provided and three or fewer layers in the other area.

According to the imaging device of the present invention, the first wiring layer includes two or fewer layers in the photosensitive area where a plurality of unit pixels are provided and three or fewer layers in the other area. With this structure, it is possible to ensure light incident upon the unit pixels in the imaging chip and reduce the area of the digital signal processing chip. In addition, it is easy to connect the imaging chip and the digital signal processing chip because at least part of the peripheral circuit section is provided on the imaging chip. Moreover, the imaging chip and the digital signal processing chip can be designed according to design rules best suited to the respective chips; therefore, fabrication of the imaging chip and the digital signal processing chip becomes easy and the cost of the fabrication can be reduced. As a result, it becomes possible to easily realize an imaging chip set capable of achieving an easy connection between the imaging chip and the DSP chip and small reduction in sensitivity due to microfabrication.

According to the imaging device chip set of the present invention, it is preferable that the first wiring layer includes an equal number of layers in the photosensitive area and the other area. In this structure, no step is formed on the surface of the first wiring layer and the imaging chip can thus be formed easily.

According to the imaging device chip set of the present invention, it is preferable that the peripheral circuit section includes a horizontal scanning section, a vertical scanning section, a horizontal timing generating section for supplying a timing signal to the horizontal scanning section, a vertical timing generating section for supplying a timing signal to the vertical scanning section, an amplifying section for amplifying the electric signal, and an analog-digital conversion section for converting the amplified electric signal to a digital signal, and the digital signal processing chip includes the vertical timing generating section and at least part of the analog-digital conversion section. In this structure, a block of large circuit size is provided on the digital signal processing chip. It is therefore possible to reduce the number of layers included in the wiring layer of the imaging chip.

According to the imaging device chip set of the present invention, it is preferable that a second wiring layer is formed on the second substrate, and the second wiring layer includes four or more layers. This structure allows efficient wiring of the DSP chip having a complicated structure, and as a result, the size of the DSP chip can be reduced.

According to the imaging device chip set of the present invention, a first transistor is formed on the first substrate; a second transistor is formed on the second substrate; and a gate insulating film of the first transistor is thicker than a gate insulating film of the second transistor. With this structure, it is possible to increase the gate breakdown voltage in the imaging chip and realize an imaging device chip set of high reliability.

According to the imaging device chip set of the present invention, a first transistor is formed on the first substrate; a second transistor is formed on the second substrate; and the first and second transistors are formed according to a design rule in which a minimum dimension of the first transistor is larger than a minimum dimension of the second transistor. With this structure, it is possible to downsize the digital signal processing chip.

According to the imaging device chip set of the present invention, it is preferable that the plurality of unit pixels are arranged one-dimensionally in the photosensitive area.

According to the imaging device chip set of the present invention, it is preferable that the plurality of unit pixels are arranged two-dimensionally in the photosensitive area.

An image pickup system of the present invention is one which includes the imaging device chip set of the present invention.

### Effects of the Invention

The imaging device chip set of the present invention is capable of achieving an easy connection between the imaging chip and the DSP chip and small reduction in sensitivity due to microfabrication.

### BRIEF DESCRIPTION OF DRAWINGS

FIG. 1 is a block diagram showing an imaging device chip set of an embodiment of the present invention.

FIG. 2 is a circuit diagram showing an example of a pixel in the imaging device chip set of an embodiment of the present invention.

FIG. 3 is a cross section showing a photosensitive area of an imaging chip in the imaging device chip set of an embodiment of the present invention.

FIG. 4 is a graph showing the correlation between the pixel pitch and the number of layers included in a wiring layer that can assure necessary sensitivity.

FIG. 5 is a cross section showing an example structure of an isolation part of an imaging chip in the imaging device chip set of an embodiment of the present invention.

FIG. 6 is a cross section showing an example structure of an isolation part of an imaging chip in the imaging device chip set of an embodiment of the present invention.

FIG. 7 is a cross section showing an example structure of a photodiode of an imaging chip in the imaging device chip set of an embodiment of the present invention.

FIG. 8 is a block diagram showing a structure of an image pickup system of an embodiment of the present invention.

### DESCRIPTION OF REFERENCE NUMERALS

11 imaging chip
12 digital signal processing chip
20 photosensitive area
21 unit pixels
22 peripheral circuit section
23 horizontal scanning section
24 vertical scanning section
25 horizontal timing generating section
26 amplifying section
31 digital signal processing section
32 vertical timing generating section
33 gain control amplifying section
34 analog-digital conversion section
41 photodiode
42 transfer transistor
43 reset transistor
44 amplifying transistor
45 read transistor
50 substrate
51 isolation part
52 floating diffusion
53 transfer gate
54 gate insulating film
55 interlayer film
56 first wiring layer
57 metal wiring
58 interlayer film
59 second wiring layer
60 microlens
61 isolation oxide film
62 isolation part
63 p-type buried layer
71 memory
72 microcontroller

### EXAMPLE EMBODIMENT

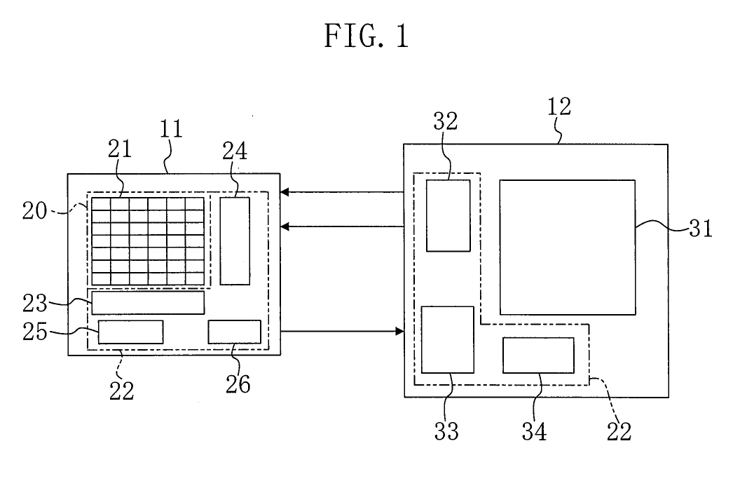

An embodiment of the present invention is described with reference to the drawings. FIG. 1 shows an example of the block configuration of an imaging device chip set according to the present embodiment. As shown in FIG. 1, the imaging device chip set of the present embodiment is composed of an imaging chip 11 and a digital signal processing (DSP) chip 12.

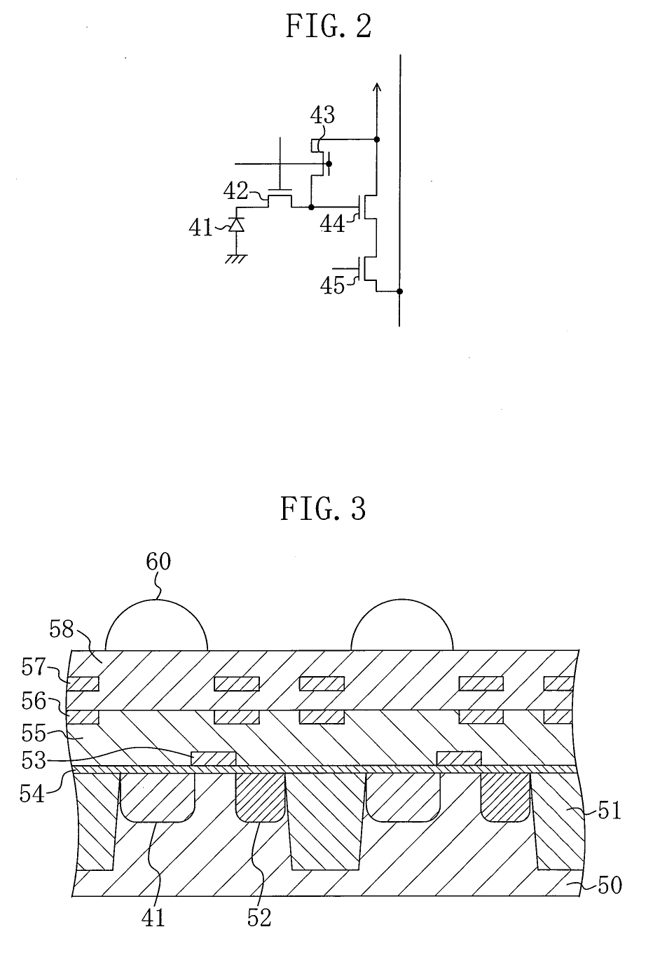

The imaging chip 11 includes a plurality of unit pixels 21 arranged in a matrix in a photosensitive area 20 and part of a peripheral circuit section 22 for driving the plurality of unit pixels 21. The peripheral circuit section 22 included in the imaging chip 11 includes a horizontal scanning section 23, a vertical scanning section 24, a horizontal timing generating section 25 for supplying a timing signal to the horizontal scanning section 23, and an amplifying section 26 for amplifying a signal read from the unit pixels 21. The unit pixels 21 can be arranged one-dimensionally. Each unit pixel 21 may have a general structure, for example, may be composed of a photodiode 41 and four transistors, namely, a transfer transistor 42, a reset transistor 43, an amplifying transistor 44 and a read transistor 45 as shown in FIG. 2. The read transistor 45 may be omitted so that the unit pixel 21 includes three transistors.

The DSP chip 12 includes a digital signal processing section 31, a vertical timing generating section 32 for supplying a timing signal to the vertical scanning section 24 of the imaging chip 11, a gain control amplifying (GCA) section 33, and an analog-digital conversion (ADC) section 34. The vertical timing generating section 32, the GCA section 33 and the ADC section 34 are included in the peripheral circuit 22 for driving the unit pixels 21.

FIG. 3 shows an example of a cross sectional structure of the photosensitive area 20 of the imaging chip 11 according to the present embodiment. As shown in FIG. 3, a plurality of regions isolated from each other by an isolation part 51 are provided in the silicon substrate 50 in the photosensitive area 20 of the imaging chip 11 according to the present embodiment. Each of the isolated regions constitutes a unit pixel 21. A unit pixel 21 includes a photodiode (PD) 41 and a floating diffusion (FD) 52 in the substrate 50. Though not shown in FIG. 3, a diffusion layer of another transistor is also provided in the substrate 50.

A transfer gate 53 of a transfer transistor is provided on the substrate 50, with a gate insulating film 54 interposed therebetween. The transfer gate 53 is configured to extend in the row direction and constitutes a gate wiring. Though not shown in FIG. 3, a gate of another transistor is also formed, part of which serves as a gate wiring. The transfer gate 53 and others are covered with an interlayer film 55 to serve as a first wiring layer 56. An on-chip microlens 60 and a metal wiring 57 which serves as a vertical signal line are provided above the interlayer film 55.

Though not shown in FIG. 3, a wiring for connecting transistors and others are also provided. The metal wiring 57 and others are covered with an interlayer film 58. A color filter may be formed between the on-chip microlens 60 and the interlayer film 55.

As in the above, there are only two layers included in the wiring layer of the photosensitive area 20 of the imaging chip 11 of the present embodiment. Because the wiring layer of the imaging chip 11 of the present embodiment includes a small number of layers, light incident from an oblique direction is not shut by the wiring layer and can reach the PD 41 efficiently.

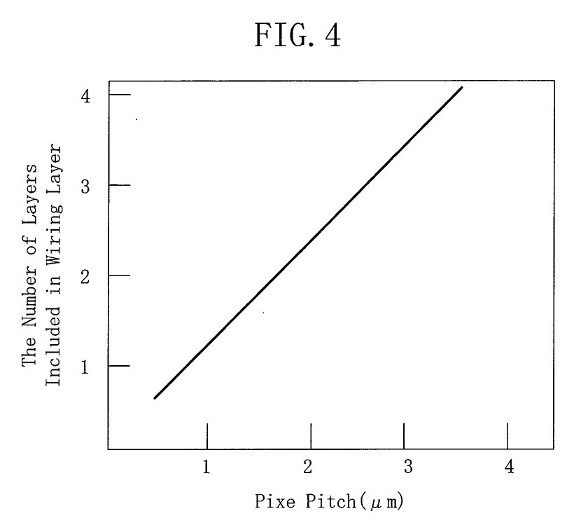

FIG. 4 shows a result of a simulation for obtaining the relationship between the pixel pitch (pixel size) and the number of layers included in the wiring layer that can assure sensitivity. The part of FIG. 4 below the solid line represents a pixel pitch that can be realized. In the case of pixel pitch of 2.8 μm, which is currently common, minimum sensitivity is assured even if the wiring layer includes three layers. It is apparent, however, that further microfabrication requires reducing the number of layers included in the wiring layer to two or less.

In the case of a common unit pixel composed of PD and four transistors, approximately four wirings per unit pixel are necessary. Hence, in the case of pixel pitch of 2.5 μm, the number of layers included in the wiring layer can be reduced to two if design rules of 0.18 μm are adopted. In the case of pixel pitch of 2.0 μm, the number of layers included in the wiring layer can also be reduced to two if design rules of 0.13 μm are adopted.

The relationship between design rules and the pixel pitch that can be achieved by two-layered wiring is briefly described. For example, the first layer of the wiring layer includes three lines, namely, a signal line, a power source line, and a local wiring inside a pixel, and the second layer of the wiring layer includes a ground line which also serves as a light shield. In this case, the first layer needs three wirings and space for two wirings.

If the design rules of 0.18 μm is adopted in the pixel pitch of 2.5 μm, a wiring section needs the width of 0.9 μm (0.18 μm×5), and therefore, the width of the area through which light passes is 1.6 μm. If the design rules of 0.13 μm is adopted in the pixel pitch of 2.0 μm, a wiring section needs the width of 0.65 μm (0.13 μm×5), and therefore, the width of the area through which light passes is 1.35 μm. It is desirable that the area through which light passes accounts for as large a percentage as possible, but the percentage needs to be at least 60% or more of a pixel. In the case of the pixel pitch of 2.5 μm and the design rules of 0.18 μm, the area through which light passes accounts for about 65% of a pixel. In the case of the pixel pitch of 2.0 μm and the design rules of 0.13 μm, the area through which light passes accounts for about 67.5% of a pixel. Consequently, the structure in which the wiring layer includes two layers is possible.

In the case where a unit pixel is composed of three transistors, the number of necessary wirings can be reduced. This enables easy achievement of the structure in which the wiring layer includes two layers. It is also possible to increase the area of PD since the number of transistors is reduced. Sensitivity can thus be improved.

It is preferable that the wiring layer of the imaging chip 11 includes an equal number of layers in the photosensitive area 20 and the area other than the photosensitive area 20 so that the chip formation process is simplified. However, a reduction in number of layers included in the wiring layer may lead to an increase in area occupied by wirings on the chip. For this reason, the wiring layer in the area other than the photosensitive area 20 may include three layers.

In order to reduce the number of layers included in the wiring layer of the area other than the photosensitive area 20 in the imaging chip 11 and reduce the area occupied by wirings, it is preferable that as many parts of the peripheral circuit section 22 as possible are included in the DSP chip 12. However, it is not realistic to include the horizontal scanning section 23, the vertical scanning section 24 and the like in the DSP chip 12 because an enormous number of wirings for connecting the imaging chip 11 and the DSP chip 12 are necessary. Which circuit block is to be included in the imaging chip 11 may be decided in view of the number of wirings between the chips, noises generated because of the connection of the chips, size of the circuit, design simplicity and the like.

For example, the ADC section 34 may be included in the imaging chip 11 although it is included in the DSP chip 12 in FIG. 1. In general, an ADC section includes a digital-analog conversion circuit for converting data converted into digital form again into an analog value to check, for correction, whether or not the value converted into digital form is correct. The digital-analog conversion circuit has a relatively large circuit size. Therefore, of the ADC section 34, the analog-digital conversion circuit part may be included in the imaging chip 11 and the digital-analog conversion circuit part may be included in the DSP chip 12.

The number of layers included in the wiring layer of the DSP chip 12 is not limited. Thus, the DSP chip 12 can be designed with flexibility. It is possible to downsize the DSP chip 12 by making the wiring layer of the DSP chip 12 have four or more layers.

The imaging chip 11 and the DSP chip 12 are separate chips and can thus be formed in different processes. For example, the imaging chip 11 and the DSP chip 12 may be structured such that the thickness of a gate insulating film of a transistor formed in the imaging chip 11 is greater than the thickness of a gate insulating film formed in the DSP chip 12. This makes it possible to reduce analog noise generated due to a leakage current flowing through the gate insulating film of the imaging chip 11.

The DSP chip 12 is a digital circuit and there is no need to consider analog noise in the DSP chip 12. Thus, the DSP chip 12 can be designed as finely as possible using leading-edge design rules.

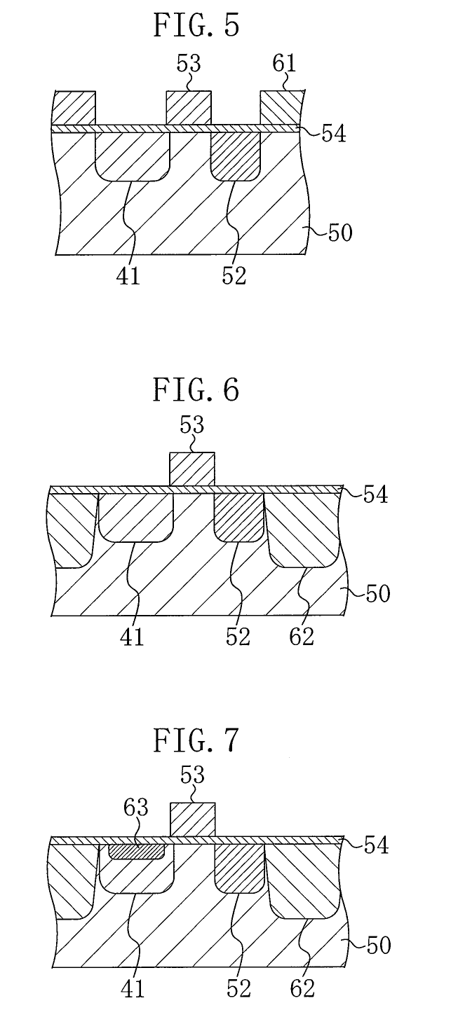

In addition, elements of the imaging chip 11 can be designed using relatively flexible design rules. Therefore isolation may be achieved by an isolation oxide film 61 on the substrate 50 as shown in FIG. 5 or by an isolation part 62 formed by ion implantation as shown in FIG. 6.

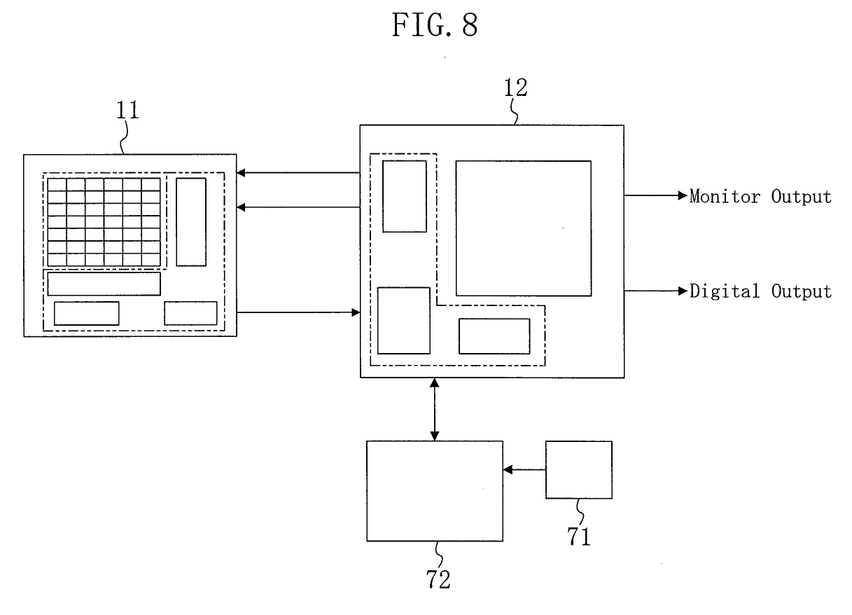

Design using flexible design rules makes it relatively easy to carry out a process in which heat is applied. The PD 41 can be formed as a buried photodiode by forming a p-type buried layer 63 in the PD 41 as shown in FIG. 7. The PD 41 as a buried photodiode can reduce a leakage current from the surface of the photodiode.

FIG. 8 shows an image pickup system which includes an imaging device chip set of the present embodiment. According to the image pickup system of the present embodiment, a program for achieving the functions, such as an electronic shutter and an auto iris, is stored in a memory 71, and the program is read by a microcontroller 72 to control the DSP chip 12 as shown in FIG. 8. The image quality of an image pickup system, such as a digital still camera, a surveillance camera and a fingerprint authentication device, can be improved by utilizing the imaging device chip set of the present embodiment in an image pickup system.

Although the example in which the wiring layer in the photosensitive area includes two layers is described in the present embodiment, the number of layers included in the wiring layer may also be one. In this case, the number of layers included in the wiring layer in the area other than the photosensitive area may be either one or two.

### INDUSTRIAL APPLICABILITY

The imaging device chip set of the present invention is capable of achieving an easy connection between the imaging chip and the DSP chip and small reduction in sensitivity due to microfabrication and is useful as a chip set including a MOS type imaging chip and a digital signal processing chip used in digital cameras and the like and as an image pickup system utilizing the same.

1-9. (canceled)

10. An imaging device chip set comprising:
an imaging chip which is formed on a first substrate and includes a plurality of unit pixels for converting incident light to an electric signal and part of a peripheral circuit section for driving the plurality of unit pixels; and
a digital signal processing chip which is formed on a second substrate and includes a digital signal processing section for converting and processing the electric signal and remaining part of the peripheral circuit section,
wherein a first wiring layer is formed on the first substrate, and
the first wiring layer includes two or fewer layers in a photosensitive area where the plurality of unit pixels are provided and three or fewer layers in the other area.

11. The imaging device chip set of claim 10, wherein the first wiring layer includes an equal number of layers in the photosensitive area and the other area.

12. The imaging device chip set of claim 10, wherein
the peripheral circuit section includes a horizontal scanning section, a vertical scanning section, a horizontal timing generating section for supplying a timing signal to the horizontal scanning section, a vertical timing generating section for supplying a timing signal to the vertical scanning section, an amplifying section for amplifying the electric signal, and an analog-digital conversion section for converting the amplified electric signal to a digital signal, and
the digital signal processing chip includes the vertical timing generating section and at least part of the analog-digital conversion section.

13. The imaging device chip set of claim 10, wherein
a second wiring layer is formed on the second substrate, and
the second wiring layer includes four or more layers.

14. The imaging device chip set of claim 10, wherein
a first transistor is formed on the first substrate,
a second transistor is formed on the second substrate, and
a gate insulating film of the first transistor is thicker than a gate insulating film of the second transistor.

15. The imaging device chip set of claim 10, wherein
a first transistor is formed on the first substrate,
a second transistor is formed on the second substrate, and
the first and second transistors are formed according to a design rule in which a minimum dimension of the first transistor is larger than a minimum dimension of the second transistor.

16. The imaging device chip set of claim 10, wherein the plurality of unit pixels are arranged one-dimensionally in the photosensitive area.

17. The imaging device chip set of claim 10, wherein the plurality of unit pixels are arranged two-dimensionally in the photosensitive area.

18. An image pickup system which includes the imaging device chip set of claim 10.
